(19) United States
(12) Patent Application Publication
(10) Pub. No.: US 2008/0276197 A1
(43) Pub. Date: Nov. 6, 2008

(54) Visualisation of Buddylist with Localisation Information

(75) Inventors: Elmo Marcus Attila Diederiks, Eindhoven (NL); Bartel Marinus Van De Sluis, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/095,758

(22) PCT Filed: Nov. 28, 2006
(86) PCT No.: PCT/IB2006/054495

§ 371 Date: Jun. 2, 2008

Related U.S. Application Data
(60) Provisional application No. 60/741,295, filed on Dec. 1, 2005.

(51) Int. Cl. G06F 3/048

(52) U.S. Cl. 715/810

(57) ABSTRACT

A system (800), apparatus (700) and method (600) are provided to visualize attributes associated with a mobile or stationary user device (100) and a list of contacts (105) contacted via a mobile or stationary contact device, the attributes being stored in an on [symbol] board persistent memory (606) and presented to the user on a screen of the device in an intuitive manner. More specifically, at least the location, and in an alternative embodiment the orientation, relative to the user of the device, of the various contacts in the contact list is represented visually using (among others) an icon, icon size, and icon color, on the screen of the user device (100).

The present invention provides a system, apparatus and method to present visualizable attributes associated with a mobile user device and a list of contacts stored therein in an intuitive manner. More specifically, at least the location and in an alternative embodiment the direction relative to the user of the device of the various contacts in the contact list is represented visually.

Increasingly, people own and carry with them personal electronic devices, such as mobile phones and personal digital assistants (PDAs). More and more of these electronic devices have localization means, such as GSM cell localization (or triangulation) or GPS.

This location information is not used to tell other people/devices where a person they are communicating with is located, although in almost every cell-phone conversation the current location of the two users is discussed.

Furthermore, all these personal devices offer some kind of contact list (or buddy list) functionality, some even provide subgroups and more advanced contact management features. For example, MSN Messenger indicates how a person can be reached (e.g., what communication channels are available).

Providing location information concerning the people in a contact list is beneficial, but is not yet an available feature of many mobile devices.

The system 800, apparatus 700, and method 600 of the present invention provide at least the most recently determined location of a user's mobile device and people of a contact list of the device, in an unobtrusive and intuitive manner whenever the devices addressed by the contact list have localization means. The location is presented in terms of the relative direction of the personal devices of the people in the contact list to the device of the user. In a preferred embodiment, this presentation of the location information includes other information such as potential interesting gatherings (and thus activities) of people in the contact list. This presentation is realized in a preferred embodiment using the location information provided by the contact persons' devices and the location of the user's device, as well as the geographical orientation of the user's device. The latter is required in order to represent the directional information concerning people in the contact list since, after the orientation of the user's device changes, its direction toward the user's contacts changes as well.

Orientation information is used to render the direction of the user and the contacts on the user's screen.

For the localization information, a preferred embodiment employs at least one well known mechanism selected from the group consisting of Global Positioning System (GPS) and GSM cell localization mechanisms. For the geographical orientation, a preferred embodiment employs an electronic compass. One skilled in the art will realize these are all state-of-the-art mechanisms that are readily available as off-the-shelf technology.

It is possible to obtain the location of any device as long as it is equipped with GPS or other localization means.

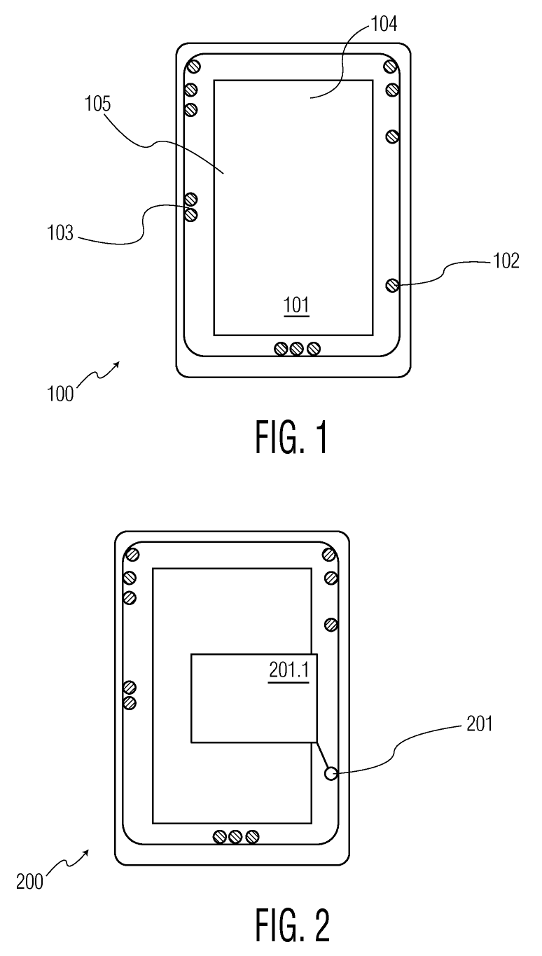

FIG. 1 illustrates a user hand-held display device displaying contacts along an edge of the display;

FIG. 2 illustrates additional options and contact information displayed in response to a user selection of a contact;

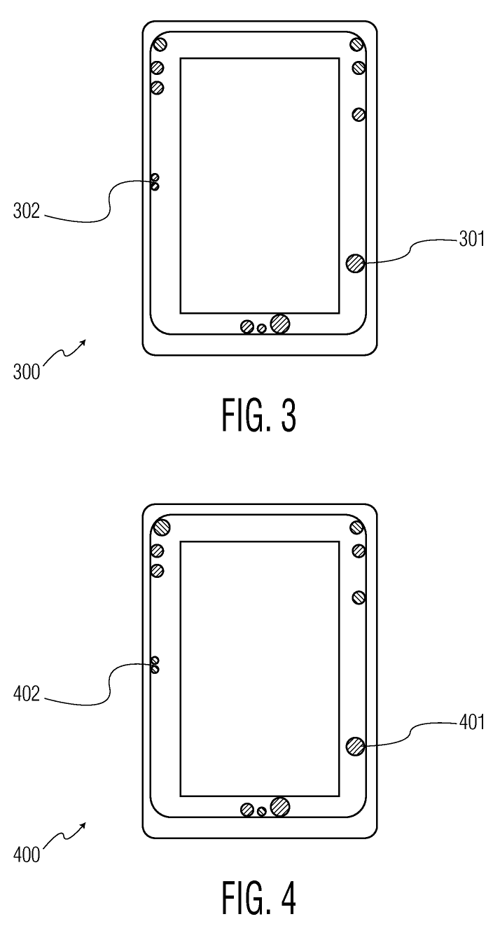

FIG. 3 illustrates a graphical representation of contacts' distances from the user hand-held device;

FIG. 4 illustrates a graphical representation of contacts' group membership;

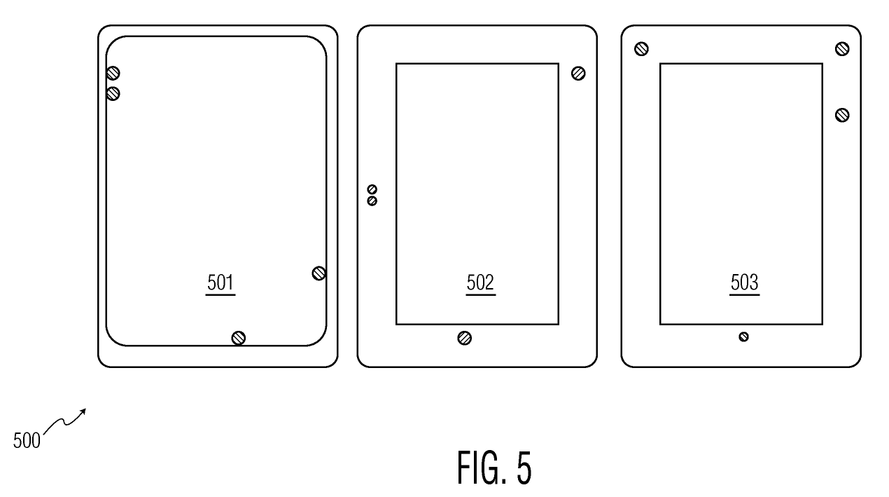

FIG. 5 illustrates an alternative visual presentation of group membership having a separate screen display for each group;

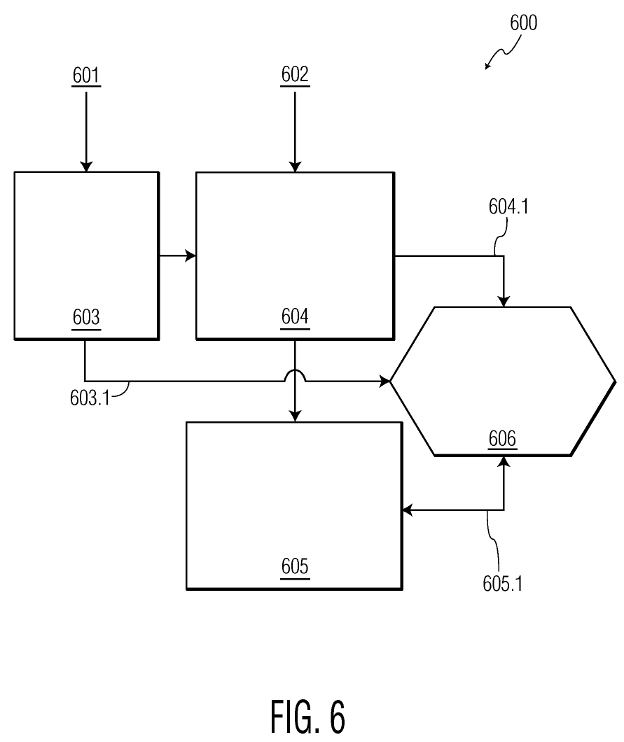

FIG. 6 illustrates a functional flow diagram of a method according to the present invention for maintaining and displaying up-to-date contact and user locations, identifying contacts that are close to one another and indicating proximity of contacts to the user;

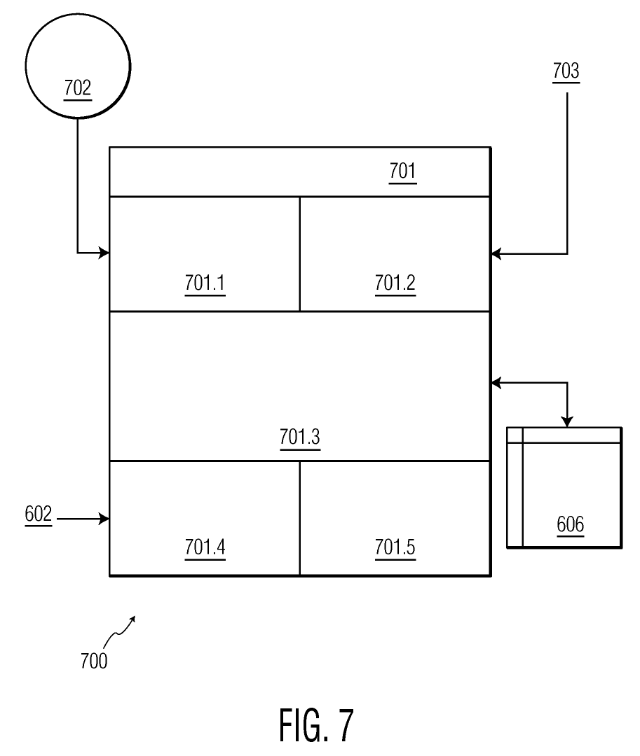

FIG. 7 illustrates an apparatus according to the present invention for associating a contact list with the location of each contact; and

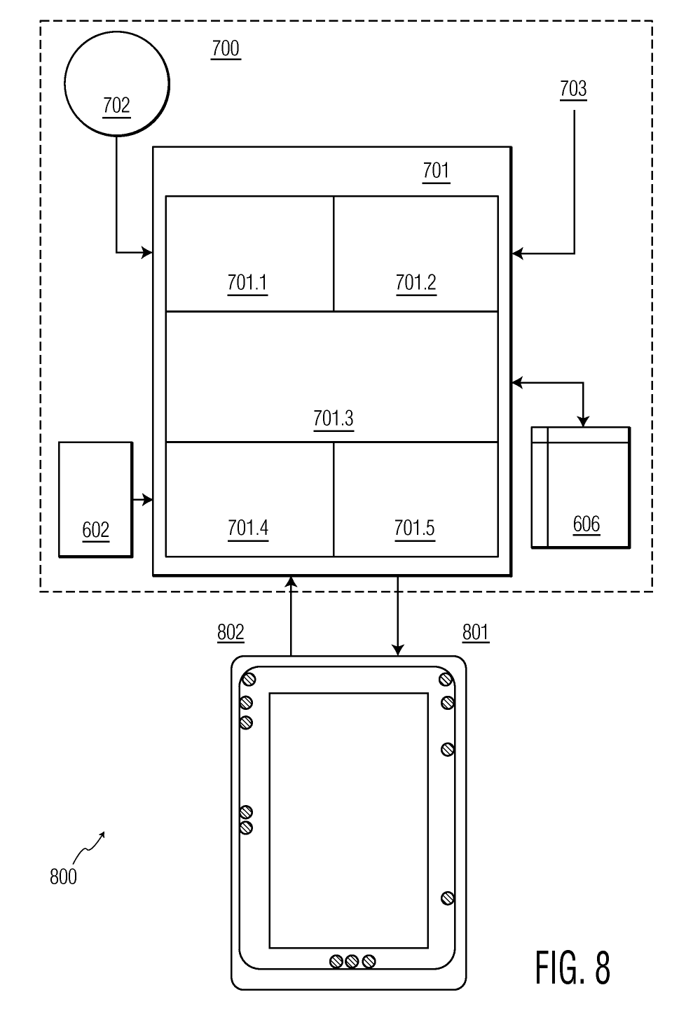

FIG. 8 illustrates a system according to the present invention.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

In a preferred embodiment, as illustrated in FIG. 1, the contacts or buddy list 105 of a user are presented at one side of the screen 101 of the user's device 100, while the middle of the screen is used for applications to run. The relative positions of the contacts to one another are represented by including the same small icon next to the names of the contacts that are close together, in this case small circles 103.

In addition, as illustrated in FIG. 2, the user is able to select a contact directly by positioning a cursor and clicking or tapping the screen with a pen 201. This results in the presentation of contact information and additional options (e.g., an option for directly calling the contact) 201.1 on the user's screen.

And, as illustrated in FIG. 3, the relative distance of the personal devices of the people in the contact list from the device of the user, can be represented as well (which provides more detailed information to the user), for example by using indicator size 301 302.

Finally, as illustrated in the device 400 of FIG. 4, it is possible to indicate to which group each contact belongs, for instance, by using color 401 402. In an alternative embodiment, as illustrated in the devices 500 of FIG. 5, the presented contacts are filtered by group 501 502 503. This filter is set by the user, for example, by clicking successively on the contact and group name and vice versa, which results in a pop up menu where the user can select a different group (not shown). Clicking on just the group name allows the changing of the group name for all contact of a group.

It is noted that a contact has the capability for having all the types of localization, group and other data associated with the contact but that this data may be null, e.g., a contact having a land line device does not normally have localization capabilities and thus this data will be null and not appear on the display of the mobile device when this contact is displayed. However, if and when land line devices can provide localization information, the present invention is intended to capture this information, store it in the persistent memory 606 associated with the contact and display it according to the present invention 100-500.

Referring now to FIG. 6, an example is illustrated of a flow diagram for a preferred embodiment of a method 600b according to the present invention. At step 601, whenever a user successfully initiates a wireless call to a contactᵢ in a contact list of a wireless device, the step 603 of the present invention is executed to update the location data for contactᵢ 603.1 stored in a persistent memory 606. Then a ‘bring-to-date’ action is invoked at step 604.

If the call is to a device not in the contact list then only a ‘bring-to-date’ action is invoked 602.

A ‘bring-to-date’ action executes at step 604 to update the user's location and geographic orientation data 604.1 stored in the persistent memory 606. That is, whenever a contact is either not in the device's contact list or does not provide its location, the action taken is to bring-to-date the user location and orientation information 605.1 in the persistent memory and then refresh (at step 605) all other proximity, groups, etc. data 605.1 based on what is now stored in the persistent memory. This very quickly refreshes all the stored data and reduces complexity of the module 605 for updating the persistent memory 606.

It is also possible for the user, who may be doing one of moving from one cell to another and changing geographic orientations, to positively invoke a ‘bring-to-date’ action to update the persistent memory 606 to reflect the user's movements.

In a preferred embodiment, a persistent memory 606 is provided to retain user and contact data resulting from the present invention.

In an alternative preferred embodiment, the refreshing of the stored data is done selectively and only for the computed data that changes as a result of changed location and orientation of the user and contacts.

Referring now to FIG. 7, an apparatus 700 is illustrated for performing the method illustrated in FIG. 6 with respect to a contact or buddy list of a user's mobile electronic device (PDA, cell phone, MP3 player, walkman-type device, digital photo camera, digital video camera, and combination of any of these devices). The apparatus 700 comprises a persistent memory 606 for storing user and contact data (including but not limited to location 603.1 604.1 and orientation data 604.1) and a processor 701 for controlling and executing a plurality of modules, including:

(1) an orientation computation module 701 that receives geographic orientation and speed for the user and contacts and computes an orientation of the user with respect to each contact and an orientation of each contact with respect to the user therefrom and stores the computed orientation data 604.1 of the user and each contact in the persistent memory 606 as well as the relative position and distance of each user/contact pair;

(2) a location computation module 701.2 that receives localization data for one of a user and contact device and computes a location therefrom and stores the computed location data 603.1 604.1 in a persistent memory 606 appropriately identified as to the user and contact in the buddy list whose location data is being stored; and

(3) an attribute computation module that retrieves user and contact location data from the persistent memory 606 and computes attribute data comprising proximity of the user to each contact, group membership of each contact, proximity of contacts to each other, and how fast and in what direction a contact is moving and stores the computed attribute data 605.1 in the persistent memory 606.

In a preferred embodiment the geographic orientation of the user is obtained by an electronic compass 702 and input to the orientation computation module 701.1.

In a preferred embodiment the localization data is provided by a user device and a contact device using GSM and GPS techniques 703.

In a preferred embodiment, the user inputs attribute data such as group membership for each contact and for the user and the input attribute data is stored in the persistent memory 606 appropriately identified as to the user and contact in the buddy list whose attribute data is being stored.

Referring now to FIG. 8, a preferred embodiment of a system 800 is illustrated incorporating the apparatus 700 of FIG. 7. The system 800 comprises a user input processing module 701.4 that captures user inputs such as contact information, group definition data and accepts user actions and executes the appropriate module of the apparatus 700 to process the user data and actions, as well as performing other processing specific to the particular user device. The system further comprises a display component generation module 701.5 that generates display components of the present invention for display on the user device's screen. These display components include an icon for contact orientation, proximity and speed relative to each other and to the user device (e.g., size of icon or color of icon), and grouping of contacts by placement of icons on the user device's screen, see FIG. 4 item 402.

Orientation information is used to render the direction of the contacts correctly on the user screen. The absolute positions of the contacts are known by means of localization information (e.g., through GPS or GSP-cell localization, or other localization data provided by each device), the direction of the location of these contacts is in fact a relative position with respect to the orientation of the device of the user (obtained, e.g., by using an electronic compass). By combining the absolute positions of the contacts and the user with the orientation of the user's device it is possible to obtain the direction of the contact relative to the user). For instance, suppose a contact is situated at coordinates (0, 40) and the user is at (0, 0): the contact is 40 miles North of the user. Now, if the user is facing North with the device, the contact is rendered at the top of the screen. If the user if facing West, the contact is rendered at the right-side of the screen. If the user is facing East, the contact is rendered at the left-side of the screen. And, if the user is facing South, the contact is rendered at the bottom of the screen.

The system 800, apparatus 700 and method 600 of the present invention are applicable to either or both the user and contact having any portable device including but not limited to cell phones, personal digital assistants (PDAs), MP3 players, walkmans digital photo cameras, digital video cameras and any combination of the foregoing devices and either or both the user and contact having any stationary device including but not limited to personal computers (PCs), televisions (TVs), and fixed location telephones.

While the preferred embodiments of the present invention have been illustrated and described, it will be understood by those skilled in the art that the system, apparatus and method as described herein are illustrative and various changes and modifications may be made and equivalents may be substituted for elements thereof without departing from the true scope of the present invention. In addition, many modifications may be made to adapt the teachings of the present invention to a particular localization mechanism (such as plain old telephone system (POTS) providing location of a landline contact's telephone) without departing from its central scope. Therefore, it is intended that the present invention not be limited to the particular embodiments disclosed as the best mode contemplated for carrying out the present invention, but that the present invention include all embodiments falling with the scope of the appended claims.

1. A method (600) for visualizing information including at least one localization attribute of a user device (100) and a contact list (105) thereof comprising the steps of:
maintaining at least one visualizable attribute comprising at least one localization attribute for each entry of the contact list (105) and for the device (100) in an on-board persistent memory (606) of the device (100);
associating a different visual cue with each said at least one maintained attribute; and
visualizing the associated visual cue of the maintained at least one visualizable attribute on a screen of the device whenever the contact list is displayed thereon.

2. The method (600) of claim 1, wherein:
the localization attribute is obtained by GPS or GSM cell localization of the contact and the device; and
the visual cue is selected from group consisting of icon and icon color (401, 402, 501-503), icon and icon size (301, 302), icon and icon proximity (103) to another icon, and any combination thereof.

3. The method of claim 1, wherein the device is a portable device selected from the group consisting of cell phone, personal digital assistant (PDA), MP3 player, walkman, digital photo camera, digital video camera, and any combination thereof.

4. The method of claim 1, wherein:
the device is a stationary device selected from the group consisting of personal computer (PC), television (TV), and landline telephone; and
further comprising the steps of:
when a contact is to be contacted via a stationary device, the user manually setting in the contact list the location of the stationary device of the contact, and
when the device is a stationary device, the user setting the user's device location manually.

5. The method (600) of claim 1, wherein the at least one visualizable attribute comprises geographic location, orientation, group membership, motion speed, distance from contact in contact list, and activity.

6. The method (600) of claim 1, wherein whenever the user is connected to a contact in the contact list (105), the maintenance step comprises performing the steps of:
maintaining an orientation attribute for each of the user with respect to the contact and the contact with respect to the user; and
maintaining a relative speed attribute of the user and the contact with respect to each other.

7. The method (600) of claim 6, further comprising the step of obtaining the orientation attribute for the user with an electronic compass (702).

8. The method (600) of claim 7, wherein the device is a portable device selected from the group consisting of cell phone, personal digital assistant (PDA), MP3 player, walkman, digital photo camera, digital video camera, and any combination thereof.

9. The method of claim 7, wherein:
the device is a stationary device selected from the group consisting of personal computer (PC), television (TV), and landline telephone; and
further comprising the steps of:
when a contact is to be contacted via a stationary device, the user manually setting in the contact list the location of the stationary device of the contact, and
when the user device is a stationary device, the user setting the user device location manually.

10. The method (600) of claim 9, wherein:
the localization attribute is obtained by GPS or GSM cell localization of the contact and the device; and
the visual cue is selected from group consisting of icon and icon color (401, 402, 501-503), icon and icon size (301, 302), icon and icon proximity (103) to another icon, and any combination thereof.

11. The method (600) of claim 1, wherein the method is initiated by the user performing one of the steps of:
executing a bring-to-date action; and
initiating a connection to a contact of the contact list (105).

12. The method (600) of claim 11, wherein whenever the user is connected to a contact in the contact list (105), the maintenance step comprises performing the steps of:
maintaining an orientation attribute for each of the user with respect to the contact and the contact with respect to the user; and
maintaining a relative speed attribute of the user and the contact with respect to each other.

13. The method (100) of claim 12, further comprising the step of obtaining the orientation attribute for the user with an electronic compass (702).

14. The method (600) of claim 13, wherein the device is a portable selected from the group consisting of cell phone, personal digital assistant (PDA), MP3 player, walkman, digital photo camera, digital video camera, and any combination thereof.

15. The method of claim 14, wherein:
the device is a stationary device selected from the group consisting of personal computer (PC), television (TV), and landline telephone; and
further comprising the steps of:
when a contact is to be contacted via a stationary device, the user manually setting in the contact list the location of the stationary device of the contact, and
when the user device is a stationary device, the user setting the user device location manually.

16. The method (600) of claim 15, wherein the visual cue is selected from group consisting of icon and icon color (401, 402, 501-503), icon and icon size (301, 302), icon and icon proximity (103) to another icon, and any combination thereof.

17. An apparatus (700) for visualization of at least one localization attribute of a user device (100) and a contact list (105) thereof comprising:
a persistent memory (606) that stores said at least one visualizable localization attribute for an entry of the contact list (105) and for the device (100); and
a processor that associates a different visual cue with each said attribute of a contact and the device, stores the attribute and associated visual cue for each contact and the device in the persistent memory, and visualizes the cue in association with the contact whenever the contact list is displayed on a screen of the device.

18. The apparatus (700) of claim 17, wherein the processor is further configured to include:
an orientation computation module (701.1) to compute an orientation of a contact of the contact list and the device as an attribute thereof at least when a connection with the contact is initiated by the device;
a localization computation module (701.2) to compute a location of a contact of the contact list and the device as an attribute thereof at least when a connection with the contact is initiated by the device; and
a contact list attribute computation module (701.3) to compute attributes other than orientation and location of a contact of the contact list and the device and store the computed attributes in the on-board persistent memory (606).

19. The apparatus (700) of claim 18, wherein the processor if further configured to include a user data input processing module (701.4) that accepts a user bring-to-date request for update of the attribute data of the contact list stored in the persistent memory (606) to reflect changes in location and orientation of the device.

20. The apparatus (700) of claim 19, wherein at least one of the user and contact have a stationary device and the user data input processing module (701.4) is further configured to accept manual input from the user concerning the location of the stationary device.

21. The apparatus (700) of claim 20, wherein the device is a stationary device selected from the group consisting of personal computer (PC), television (TV), and fixed telephone.

22. The apparatus (700) of claim 19, wherein the device is a portable device selected from the group consisting of cell phone, personal digital assistant (PDA), MP3 player, walkman, digital photo camera, digital video camera, and any combination thereof.

23. The apparatus (700) of claim 19, wherein the device is a stationary device selected from the group consisting of personal computer (PC), television (TV), and fixed telephone.

24. The apparatus (700) of claim 19, wherein the processor is further configured to include a display generation module (701.5) to retrieve from the on-board persistent memory (606) and display on the screen the visual cue for each entry in the contact list, whenever the contact list is displayed on the screen.

25. The apparatus (700) of claim 18, wherein the orientation data for the device is obtained from an electronic compass (702).

26. The apparatus (700) of claim 19, wherein:
the localization attribute is obtained by GPS or GSM cell localization of the contact and the device; and
the visual cue is selected from group consisting of icon and icon color (401, 402, 501-503), icon and icon size (301, 302), icon and icon proximity (103) to another icon, and any combination thereof.

27. A system (800) for visualization of at least one localization attribute of a user device (100) and a contact list (105) thereof comprising:
an apparatus according to claim 22 for acquisition, maintenance and storage of device attributes and contact list attributes; and
a device having a screen and user input means (602, 802), said device being selected from the group consisting of a portable device and a stationary device modified to include and interface with the apparatus,
wherein, the device accepts user inputs via the input means (602, 802) and visualizes the at least one localization attribute on a screen thereof.

28. The system of claim 26, wherein:
the portable device is selected from the group consisting of cell phone, personal digital assistant (PDA), MP3 player, walkman, digital photo camera, digital video camera, and any combination thereof;
the stationary device is selected from the group consisting of personal computer (PC), television (TV), and land line telephone; and
when a contact is to be contacted via a stationary device, the user input means (602, 802) is further configured to accept a manual setting for the contact list location of the stationary device of the contact, and
when the user device is a stationary device, the user input means (602, 802) is further configured to accept a manual setting the location of the user device.
